(19) United States
(12) Patent Application Publication
(10) Pub. No.: US 2026/0014759 A1
(43) Pub. Date: Jan. 15, 2026

(54) CONFORMAL MOTION PLANNING METHOD USING DISTORTED NURBS SURFACE AND TOOLPATH MESH INTERPOLATION

(71) Applicant: Iowa State University Research Foundation, Inc., Ames, IA (US)

(72) Inventors: Ethan B. Secor, Ames, IA (US); Jeremy D. Rurup, Ames, IA (US)

(73) Assignee: Iowa State University Research Foundation, Inc., Ames, IA (US)

(21) Appl. No.: 19/268,559

(22) Filed: Jul. 14, 2025

Related U.S. Application Data
(60) Provisional application No. 63/671,496, filed on Jul. 15, 2024.

(51) Int. Cl. B29C 64/393; B29C 64/159; B33Y 50/02

(52) U.S. Cl. CPC B29C 64/393; B29C 64/159; B33Y 50/02

(57) ABSTRACT

Presented are systems and methods that provide conformal design and motion planning that wraps a two-dimensional pattern onto a three-dimensional surface. Such systems and methods utilize a parameterization of the 3D surface in two dimensions, preferably using non-uniform rational B-splines (NURBS). Such systems and methods then provide an optimization of the parameterized surface to minimize distortion, preferably by maintaining point-to-point distances along the parametric coordinates, but with a generalizable approach to support custom constraints. Interpolation of 2D toolpath coordinates or other 2D patterns on this distorted mesh is then performed. Once complete, the parametric pattern values are remapped to 3D space using the parametric surface definition.

### CROSS-REFERENCE TO RELATED PATENT APPLICATIONS

This patent application claims the benefit of U.S. Provisional Patent Application No. 63/671,496, filed Jul. 15, 2025, the entire teachings and disclosure of which are incorporated herein by reference thereto.

### STATEMENT REGARDING FEDERALLY SPONSORED RESEARCH AND DEVELOPMENT

This invention was made with government support under CMMI2224303 awarded by the National Science Foundation. The government has certain rights in the invention.

### FIELD OF THE INVENTION

This invention generally relates to conformal design and motion planning, and more particularly to conformal design and motion planning that wraps a two-dimensional pattern onto a three-dimensional surface for conformal patterning.

### BACKGROUND OF THE INVENTION

A wide range of applications require mapping a 2D geometry onto a 3D surface. For a doubly curved surface, this cannot be achieved without some distortion. This is a common problem in manufacturing settings.

For example, in digital printing, a computer-controlled fabrication system is programmed to carry out a motion path that defines the print geometry. There are different protocols for this toolpath, with gcode being a fairly common example. In general, this toolpath defines a series of points that the printer moves through to create the target pattern. Many tools exist for generating toolpaths, including open-source programs such as Slic3r for 3D printing, but these are largely used for layer-by-layer printing. So, while the printer can move in x, y, and z directions, printing a single layer only involves motion in the x-y plane.

Rather than printing on a flat surface, conformal printing requires that this x-y toolpath be either projected onto a 3D surface or wrapped onto it. Projection often results in substantial distortion of the toolpath and is not possible for certain surface geometries. Wrapping the 2D toolpath onto a 3D surface with precise control can be challenging and lacks a well-defined solution.

Similar challenges appear when designing 3D surface geometry in a computer aided design (CAD) software from an initial 2D design. Many standard CAD and simulation packages, such as Solidworks, Autodesk Inventor, and Ansys, have features for performing both projections and wraps of 2D sketches or other geometry to 3D surfaces. However, these often lack user-adjustable parameters to control distortion.

Based on these foregoing limitations in the prior art, a need has been recognized by the inventors of the present application for a system and method to perform this wrapping operation in a simple, tunable way that scales to complex 2D toolpaths and CAD designs.

### BRIEF SUMMARY OF THE INVENTION

Embodiments of the present invention provide a system and method for quick and intuitive wrapping of a two-dimensional collection of points onto a three-dimensional surface. Such systems and methods are directly applicable to motion planning for conformal printing and 3D surface design. While specific embodiments of the system and method will be discussed hereinbelow in a conformal printing environment, the system and method have broader relevance for integration of electronics, e.g., antennas, sensors, circuitry, etc., onto 3D surfaces to provide enhanced functionality in aerospace, automotive, biomedical, and other fields. Thus, embodiments of the presently disclosed system and method facilitate the creation of motion commands for 2D patterns and mapping those 2D patterns onto a 3D surface, addressing the complex challenge described above.

In one embodiment of the present invention, as differentiated from simple pattern projection approaches, distances between points on the 3D surface are preserved to the extent possible in the most standard cases. This provides a distinct advantage for defining a shape with specified electrical properties or precise thickness, where distortion of the toolpath would be detrimental to overall performance. As an alternative embodiment, angles or areas could be preserved to the extent possible, or a combination of distances, angles, and areas.

In an embodiment of the present invention, three components are utilized, to wit, non-uniform rational B-splines (NURBS) for surface representation, a generalized strain energy minimization approach for optimization, and interpolation using methods from finite elements. While each of these components are reasonably well-established and understood by those skilled in the art individually, the uniqueness and novelty of the presently disclosed method and system come in combining these different domains as will be discussed more fully hereinbelow, an approach of which the inventors are unaware in any prior work.

In certain embodiments of the present invention, the physical and computational challenges associated with conformal patterning on curved surfaces are overcome for systems using aerosol printing technology. During the aerosol printing process, a high resolution (e.g., ˜20 micron line width) stream of small (˜1 micron) ink droplets is deposited, which can contain functional materials such as silver. In this embodiment the system utilizes a programmable motion system to enable printing of precise electronic wiring, devices, and circuits.

Aerosol printing is well-suited to printing on curved objects, because the printhead can be separated from the target surface by a range spanning at least one to five millimeters. This non-contact printing utilizing embodiments of the present invention allows fabrication of functional electronic devices on large, curved surfaces such as airplane wings, turbine blades, vehicles and more, along with conformal printing of strain sensors on curved composite parts. Such embodiments utilize algorithms for navigating the 3D print head along the curved surface, as well as CAD tools to accurately model the curved object to be 3D printed.

In embodiments of the present invention, the systems and methods provide conformal motion planning and 3D surface design that wraps a two-dimensional pattern onto a three-dimensional surface. Such systems and methods utilize a parameterization of the 3D surface in two dimensions, preferably using non-uniform rational B-splines (NURBS). Such systems and methods then provide an optimization of the parameterized surface, e.g., to minimize distortion, preferably by maintaining point-to-point distances along the parametric coordinates, but with a generalizable approach to support custom constraints. Interpolation of the 2D toolpath or design coordinates on this distorted mesh is then performed. Once complete, the parametric toolpath values are remapped to 3D space using the NURBS definition.

In preferred embodiments, in addition to 3D positions at each toolpath point, the NURBS definition allows straightforward calculation of surface normal direction using a continuous, curved surface representation to support multi-axis motion planning.

In certain embodiments, first the NURBS surface is flattened into a 2D space. Crude optimization is performed to let nodes that have known spacing in u/v space relax into a configuration that reflects their real-space (3D) distance. This creates a 2D canvas on which a 2D pattern is drawn. Advantageously, this 2D canvas does not need to be rectangular, e.g., when used for a larger section of a cone, a grid of points that is rectangular in u/v space and comprises the canvas may be arranged in a more trapezoidal shape following strain energy minimization. Then, the toolpath points are interpolated on the grid of NURBS evaluation points to find their (u, v) values. Such (u, v) values then allow the system and method to easily provide a transformation into x, y, z space, and surface normal or Euler angles.

An advantage provided by certain embodiments of the presently disclosed method is that, while patterns (such as toolpaths) can be very complex and long in 2D (particularly with infill), the complexity and computational cost of this method is primarily based on the surface geometry, and for an arbitrarily complex pattern, the method will substantially preserve its spatial dimensions. There are sophisticated electronics design tools for 2D, and plenty of slicers for optimization of 2D toolpaths, and embodiments of the presently disclosed method and system are compatible with those tools, which provides real value in lowering the skill barrier, time, and computation cost to generating patterns on 3D geometries.

In other embodiments of the present invention, aerosol printing and isoparametric maps are provided, and more particularly systems and methods of inverting isoparametric maps by finding local finite element coordinates within a grid of NURBS node points given the x,y coordinates to enable aerosol printing on 3D surfaces.

Other aspects, objectives and advantages of the invention will become more apparent from the following detailed description when taken in conjunction with the accompanying drawings.

### BRIEF DESCRIPTION OF THE DRAWINGS

The patent or application file contains at least one drawing executed in color. Copies of this patent or patent application publication with color drawings will be provided by the Office upon request and payment of the necessary fee.

The accompanying drawings incorporated in and forming a part of the specification illustrate several aspects of the present invention and, together with the description, serve to explain the principles of the invention. In the drawings:

FIGS. 1A and 1B are schematic representations of flow diagrams for a method of generating a conformal toolpath in accordance with one or more embodiments of the present disclosure:

FIGS. 2A-2C illustrate a motion system having a 6-axis robotic arm used as a conformal aerosol printer to print electronics on 3D surfaces, in accordance with one or more embodiments of the present disclosure:

FIGS. 3A and 3B depict an example of the distortion of a 2D geometry mapped to a 3D surface:

FIGS. 4A and 4B provide a conceptual representation of the ability to change the local stiffness in a region of a 2D geometry on a 3D surface, according to one or more embodiments of the present disclosure; and

FIGS. 5A-5C depict a decrease in local distortion and strain energy for a 2D geometry applied to a 3D surface by increasing the stiffness locally, according to one or more embodiments of the present disclosure.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

Various embodiments of a method and system for conformal design or additive/subtractive manufacturing on a three-dimensional surface are disclosed herein. As will be described more fully below, a three-dimensional (3D) surface is parameterized using a 2-dimensional (2D) representation. To this 2D representation, a 2D pattern, such as a toolpath, is applied, and the patterned 2D representation is re-converted to 3D space for application of the 2D pattern to the 3D surface. Then, using a manufacturing platform, such as a 3D printer or machining device, the 2D pattern can be applied to a 3D object. Advantageously, embodiments of the presently disclosed method and system allow for certain optimizations to be made when converting the 3D surface to a flattened 2D representation. An example of such an optimization is strain reduction or minimization of local distortion in a desired region. These and other aspects and advantages will be described more fully below and in relation to the figures. The embodiments presented herein are provided by way of illustration and not limitation.

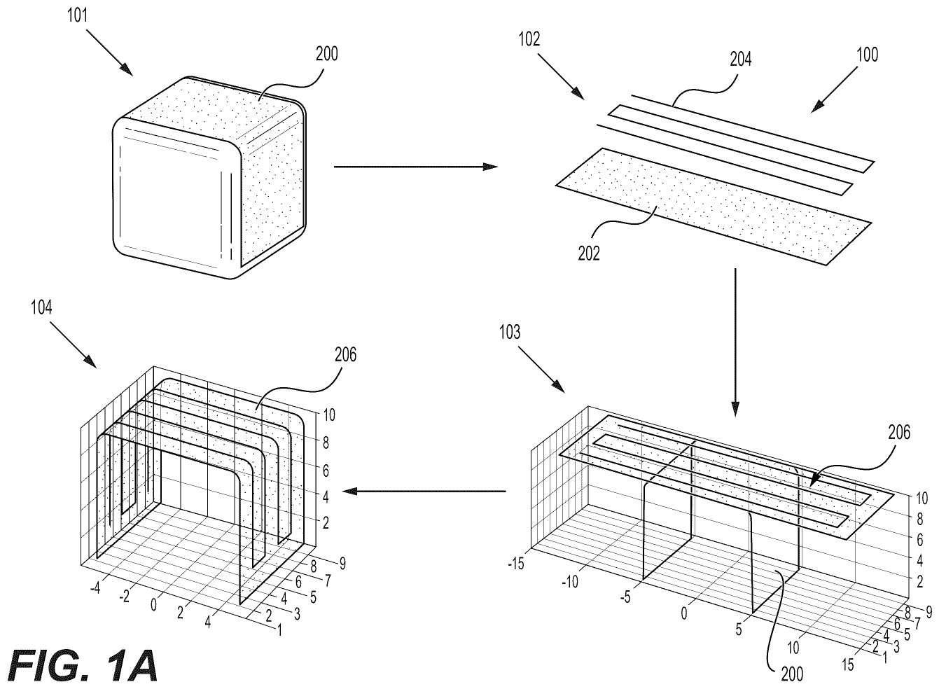

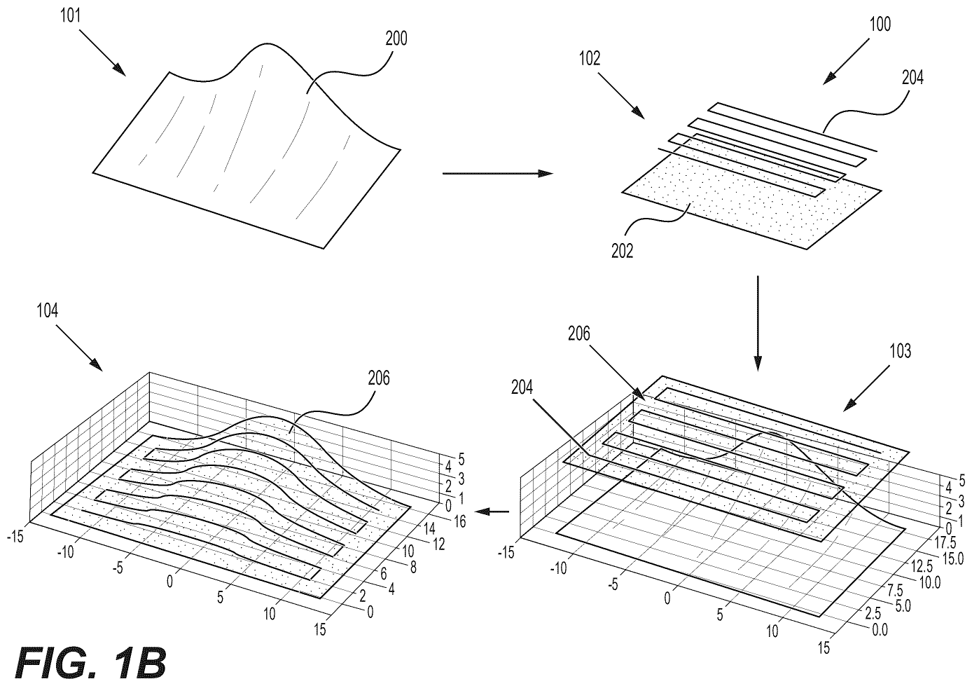

A general workflow of a method 100 of embodiments of the present disclosure is schematically shown in the flow diagram of FIGS. 1A and 1B to which reference is now made. Referring first to FIG. 1A, the method 100 involves a first step 101 of parameterizing a 3D surface 200 in two dimensions. In one or more embodiments, the surface 200 is defined in 3D space using, for example, CAD software or via a 3D scanner. The 3D surface 200 is parameterized in two dimensions using mathematical models or functions, preferably using a non-uniform rational B-spline (NURBS) representation. A NURBS representation parameterizes the three Cartesian coordinates (i.e., x, y, and z) with two parameters (by convention, u and v) to define a flattened 2D canvas 202. The NURBS representation is a continuous function defined by a knot vector and control points in u and v parameters, and is a standard method for surface representation in, for example, solid modeling graphics.

Parameterizing the 3D surface 200 to form the 2D canvas 202 generally creates distortion between points in the 3D geometry as compared to the 2D representation. For surfaces that are only single-curved, flattening the 3D surface to the 2D canvas can be done without distortion, but for more complex surfaces, some distortion of the surface is unavoidable. As will be discussed more fully below; these distortions are addressed in the 2D canvas 202 rather than distorting the 2D pattern 204 applied to the 2D canvas.

Thus, in a second step 102 of the method 100, the NURBS surface is optimized using any of a variety of known optimization functions to minimize distortions in the 2D canvas 202. Embodiments of the disclosed method 100 allow control over how and where that distortion is accommodated. In the most standard case, this distortion could be done to minimize error in the point-to-point distances between neighboring mesh points defined by u and v NURBS parameters. For example, the error in local point-to-point distances between the 3D space and the flattened 2D space may be referred to as “strain,” and the “strain energy.” can be minimized using Newton's method and/or gradient descent algorithms, amongst other possibilities known in the art. The strain energy is, in particular, based on the distortion that the surface experiences when 3D surface is flattened into a 2D plane. This energy is calculated based on a “stiffness” of the material (which can vary as a function of position on the surface) and the strain, which as mentioned above is the change in distance between two points in the 2D canvas as comparted to their equilibrium distance in the 3D space.

In one or more other embodiments, the optimization function for distortion is defined to preserve angle accuracy or to define critical regions of the surface that have a stronger reward for the optimization function, amongst other possibilities.

In one or more embodiments, surface flattening and optimization is done by: (1) scaling the 2D canvas based on average real-space distances along the surface in the u-and v-directions: and (2) performing iterative adjustments to the node points based on a strain energy minimization principle. The presently disclosed system and method also allows fine-tuned customization by. e.g., imposing constraints and allowing variable stiffness to modulate distortion.

Once the NURBS surface is optimized, the canvas 202 defines the 2D space over which 2D patterns 204, such as toolpaths, design sketches, points, lines, or open or closed curves (whether filled or unfilled) can be drawn. In a third step 103 of the method 100, the 2D patterns are incorporated in the process flow at this point, and (u, v) parameters at each position in the patterned 2D canvas 206, which are in one or more embodiments interpolated for long motion segments to avoid errors arising from curvature, are calculated, mapping the toolpath to the parametric (u, v) space. Advantageously, because the strain energy is optimized for the surface itself, the strain energy is agnostic to the material on which the pattern is applied. Therefore, once the transformation for the surface is computed, any arbitrarily complex pattern/toolpath can be interpolated onto the 2D canvas 202 so that the surface transformation can be reused.

In a fourth step 104 of the method 100, the values of the patterned 2D canvas 206 are remapped to the 3D surface 200. In this way, the 2D pattern can be translated into machine code for a tool for manufacturing on the 3D surface. In one or more such embodiments, the 2D pattern defines features added to the 3D surface 200 by the tool in the manufacturing operation (e.g., aerosol printing. 3D printing, etc.), and in one or more other embodiments, the 2D pattern defines features subtracted from the 3D surface 200 by the tool in the manufacturing operation (e.g., routing, laser ablation, etc.). This directly provides (x, y, z) values for all pattern positions, and the NURBS surface representation offers simple calculation of surface normal vectors to compute toolpaths, especially for higher-axis motion systems (e.g., 5-axis or higher tools).

Advantageously, embodiments of the presently disclosed method 100 provide a simple, lightweight (computationally), and adjustable way to minimize distortions in a 2D pattern, such as a tool path, over a 3D surface. Standard methods for conformal motion planning are often linked to CAD geometry representations and require complex kinematic transformations for a 3D pattern or a 3D toolpath. In an embodiment of the presently disclosed method 100, the pattern geometry is first defined in 2D, allowing very complex patterns to be created. Moreover, preserving distance between points during the mapping is critical for additive methods, as the pitch between adjacent “parallel” lines determines material build-up from the surface. Preserving angle, area, or a combination of these and distance allows broader control over the particular mapping for general utility.

For parts in which the pattern length, spacing, or thickness/depth, must be well controlled, this provides a clear advantage to a projection-based methodology in which a 2D toolpath is simply projected onto the surface of a 3D part. Such a projection method may be suitable for very low-curvature, nearly-flat parts, but for more complex curvatures, true wrapping of the toolpath as described in the present disclosure is advantageous.

In contrast to NURBS, another common method for surface representation is to use a tessellated surface, typically formed of triangles (e.g., STL format). A limitation of this conventional method is that it has poor scalability. To resolve fine features, the tessellated surface requires very small triangles, whereas a NURBS surface is a continuous, curved function. This is also important for extracting surface normal information, as a NURBS surface leads to smooth variation in surface normal, while a tessellated surface does not have local curvature and instead has discontinuous changes in surface normal direction. The NURBS definition used in embodiments of the presently disclosed method provide a computationally lightweight approach because the surface can be described with a concise set of control points and knots, leading to a more computationally efficient method.

FIG. 1B provides another example of the method 100 according to the present disclosure. Starting with the 3D surface 200 that has been generated (e.g., using a 3D scanner) or defined (e.g., using CAD software), the 3D surface 200 is parameterized in two dimensions to form a 2D canvas 202 in the first step 101 of the method 100. In the embodiment shown in FIG. 1B, the surface 200 is a saddle shape having cross curvatures, i.e., curvatures defined across the width and along the length of the surface 200. In a second step 102 of the method 100, the 2D canvas 202 is optimized to address distortions such that, in a third step, a 2D pattern (e.g., tool path 204) can be interpolated on the 2D canvas 202 to form a patterned 2D canvas 206. In a fourth step 104 of the method 100, this patterned 2D canvas 206 is remapped back into the 3D real space, wrapping the patterned 2D canvas 206 onto the 3D surface 200.

In one or more embodiments, the foregoing method can be carried out using a system controlled by a controller (not shown). The controller includes a processor and memory in which the memory stores program code that, when executed by the processor, is configured to capture through an input device (e.g., 3D scanner), receive through a transfer of data, or develop using computer-aided design (CAD) software a 3D surface. Further, when the program code is executed by the processor, the controller is configured to parameterize the 3D surface onto a 2D canvas, apply one or more optimization functions to the 2D canvas, interpolate a 2D pattern onto the 2D canvas to prepare a patterned 2D canvas, and remap the 2D canvas to a 3D coordinate system. In one or more embodiments, the controller is embodied in a computer, for example. Further, in one or more embodiments, the program code is stored on a non-transitory, computer-readable storage medium, such as a hard disk drive, solid state drive, flash drive, CD-ROM, DVD, or RAM, amongst other possibilities.

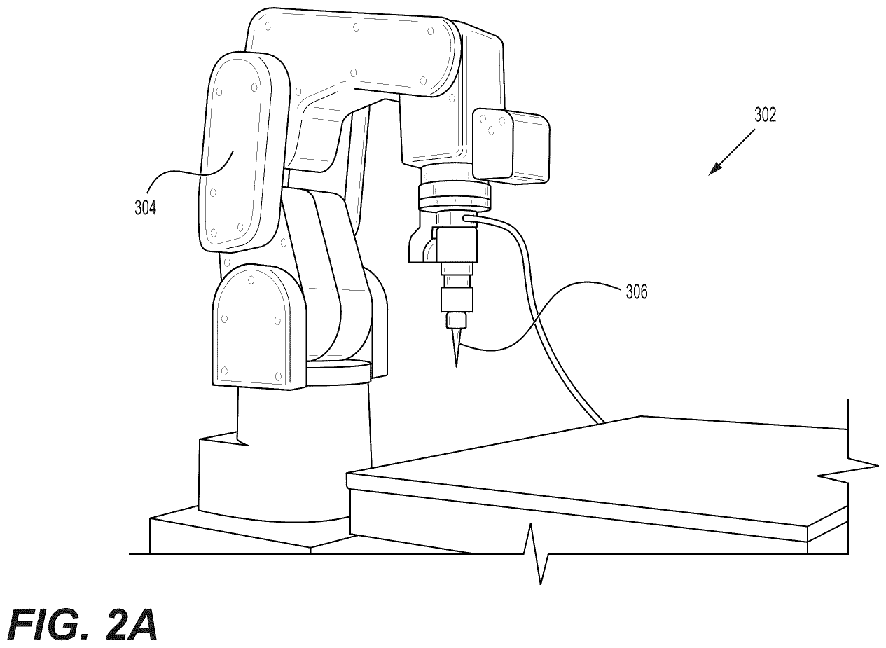

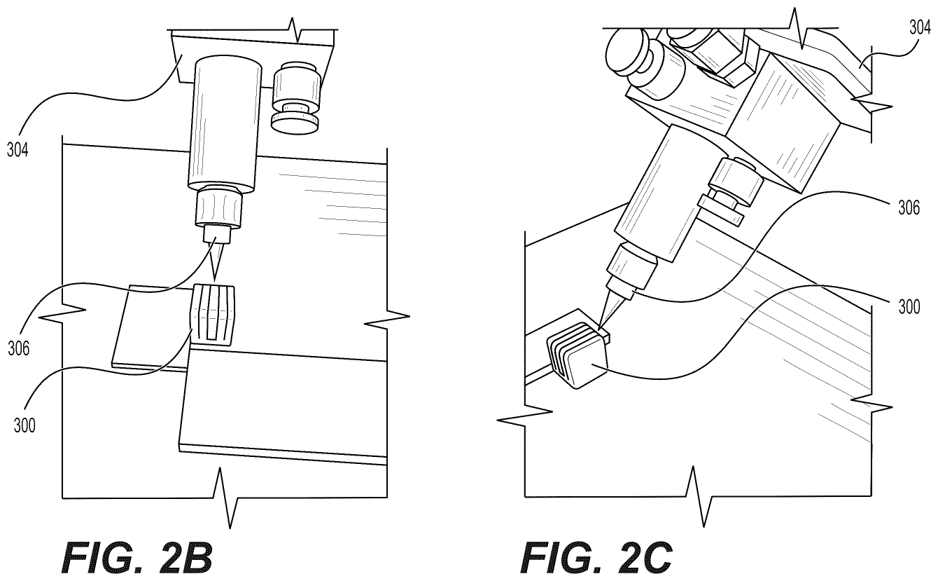

With reference to FIGS. 2A-2C, the method 100 used in embodiments of the present disclosure is illustrated for conformal aerosol printing onto three faces of a cube 300. In particular, FIGS. 2A-2C depict a motion system 302 including a 6-axis robot arm 304 having a tool tip 306 disposed at an end of the robot arm 304, requiring toolpath points based on the Cartesian x,y,z. coordinates and the Euler angles defining the surface normal vector. This motion system 302 is merely exemplary, and embodiments of the presently disclosed method are equally applicable to other motion systems 302 having other additive or subtractive tool tips 306 and/or other robotic arms having more or less axes of movement. As described above, the NURBS representation provides simple calculation of the surface normal vector, and thus Euler angles, using methods known to those of ordinary skill in the art to quickly compute the motion commands necessary to fabricate the wrapped toolpath.

In one or more embodiments, the motion system 302 is controlled by a controller (not shown). The controller includes a processor and memory in which the memory stores program code (e.g., gcode) that, when executed by the processor, is configured to cause the tool tip 306 to follow the tool path as generated according to the foregoing method over the 3D surface. That is, the controller of the motion system 302 is configured to receive the Cartesian coordinates (x, y, z) generated through the method as described above. In one or more embodiments, the controller is embodied in an industrial computer, microcontroller, FPGA, PLC, or PAC, amongst other possibilities.

In the embodiment depicted in FIGS. 2A-2C, the NURBS surface is defined conventionally using polynomials based on the Cox-de Boor recursion formula. Functions to handle NURBS surfaces are well established, and the NURBS-Python library was utilized to define the surfaces according to this particular embodiment. The flattening and distortion minimization of the NURBS surface used a simplified strain energy minimization approach (e.g., using Newton's method and/or gradient descent algorithm) with a discrete set of nodes indexed to a grid of (u, v) coordinates. The real space distance between neighboring nodes was considered an equilibrium position, and deviation from this resulted in internal stresses.

The mesh of nodes was allowed to relax in the flattened 2D space until a convergence threshold was reached (e.g., using Newton's method and/or a gradient descent algorithm), resulting in the canvas for toolpath definition. A gcode pattern was imported and segmented based on a maximum line segment size. The gcode is specific to the printed pattern but is generated without any awareness of the cube geometry. Gcode can be written using any of a variety of software packages, such as Slic3r, amongst other 3D printing slicer software packages. However, any machine code configured to define a toolpath and that could be expressed as point-to-point motions can be used. Each gcode coordinate (real space 2D) was mapped onto the corresponding parametric (u, v) by adapting mesh interpolation approaches similar to finite element methods, e.g., Newton's method to minimize the residual in the inverse isoparametric mapping based on the local node (u, v) values.

As described above, the parametric (u, v) values for each toolpath or design point are then mapped back into the real 3D space of the conformal print using the original NURBS definition. In this way, all pattern positions in the distorted pattern directly map to the conformal surface of the cube 300. This represents a unique and useful combination of NURBS surface parameterization, strain energy minimization for optimization of the flattened 2D canvas, and isoparametric mapping from finite element methods well suited to the requirements of conformal motion planning.

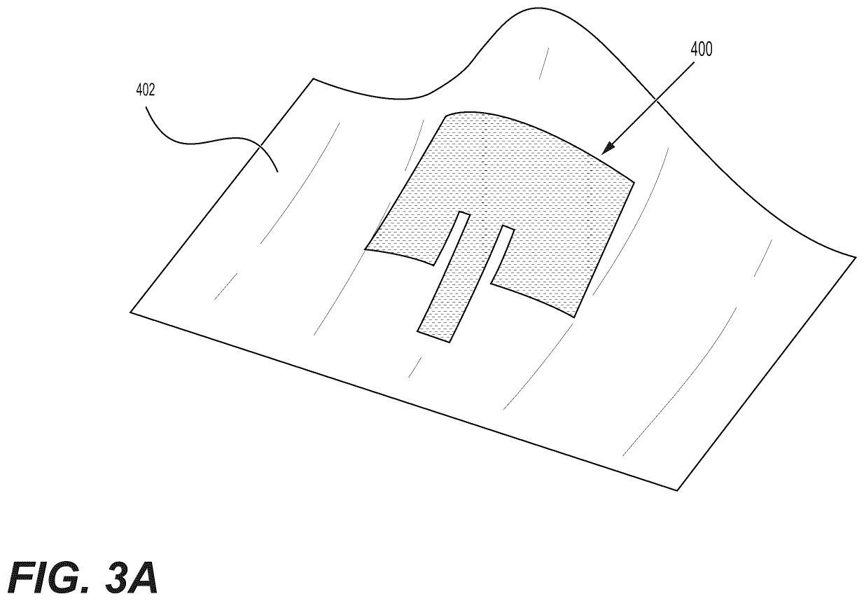

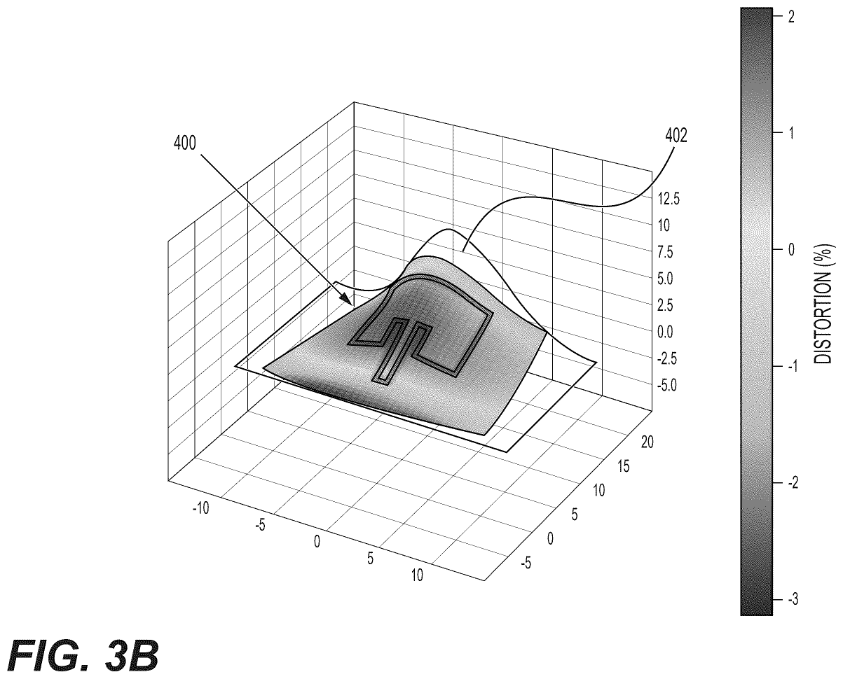

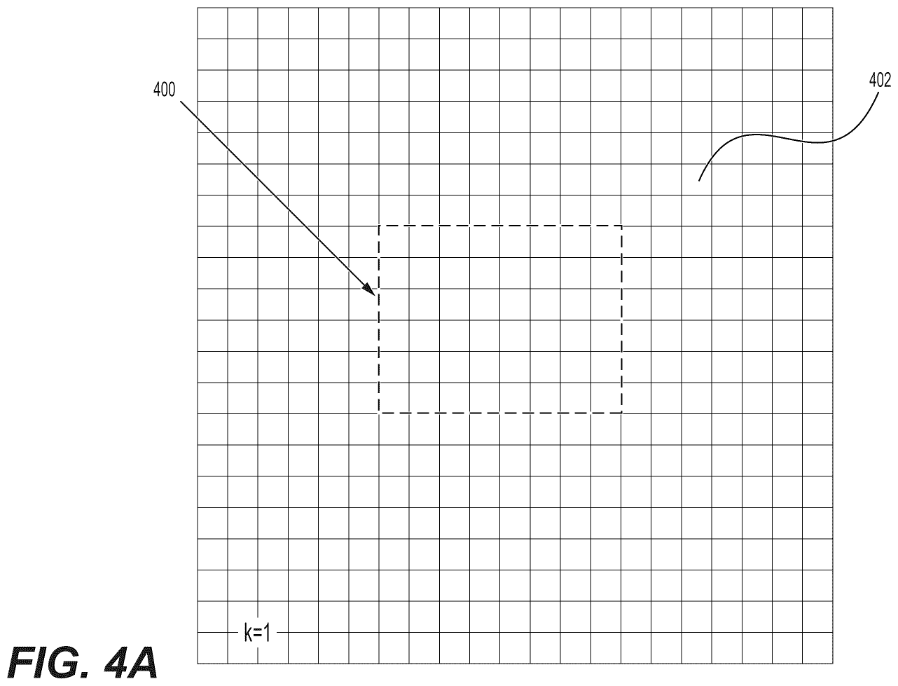

As discussed above, one advantage of the presently disclosed method is the ability to tailor distortion locally. This concept is illustrated more fully in relation to FIGS. 3A and 3B. As shown in FIG. 3A, a 2D geometry 400, such as a patch antenna, is wrapped onto a 3D surface 402, which is in particular a saddle geometry. Conventionally, a relatively large amount of distortion is present exactly where the 2D geometry is being placed. FIG. 3B specifically depicts mechanical strain in the X-direction in which the strain is the percentage difference between the original and final node-to-node distances, and the severity is indicated based on the shade scaling (assuming the same stiffness applied across the 2D geometry 400 wrapped over the 3D surface 402).

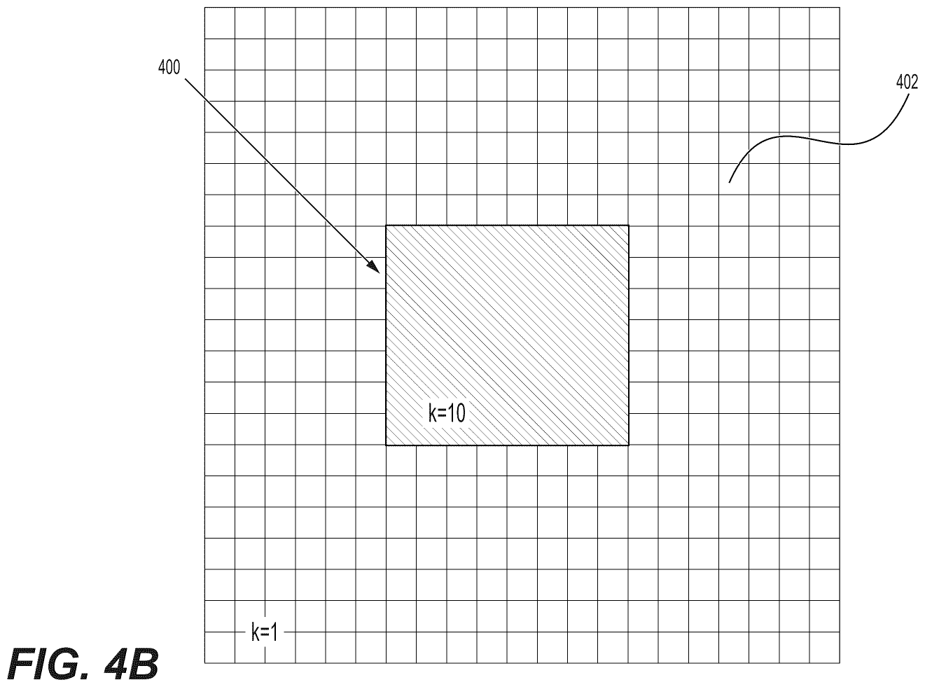

As alluded to above, the stiffness may be adjusted locally to make specific regions of the 3D surface 402 more or less rigid. The optimization algorithm then attempts to minimize total strain energy for the full 3D surface 402, but in the example of FIGS. 3A and 3B, the distortion immediately surrounding the 2D geometry 400 is of primary concern. By increasing the relative stiffness in this region-of-interest compared to the surrounding regions, local distortion for the manufactured 2D geometry can be reduced. FIGS. 4A and 4B illustrate this optimization conceptionally. In particular, FIG. 4A shows the 2D canvas of the 3D surface 402 in which the stiffness is the same over the entire area. According to the present disclosure, the stiffness of the 3D surface 402 in the region where the 2D geometry 400 is provided is given a higher stiffness, a 10:1 ratio in the embodiment depicted. Thus, when mapping the tool path onto the 2D canvas, the distortion is lessened in the desired region.

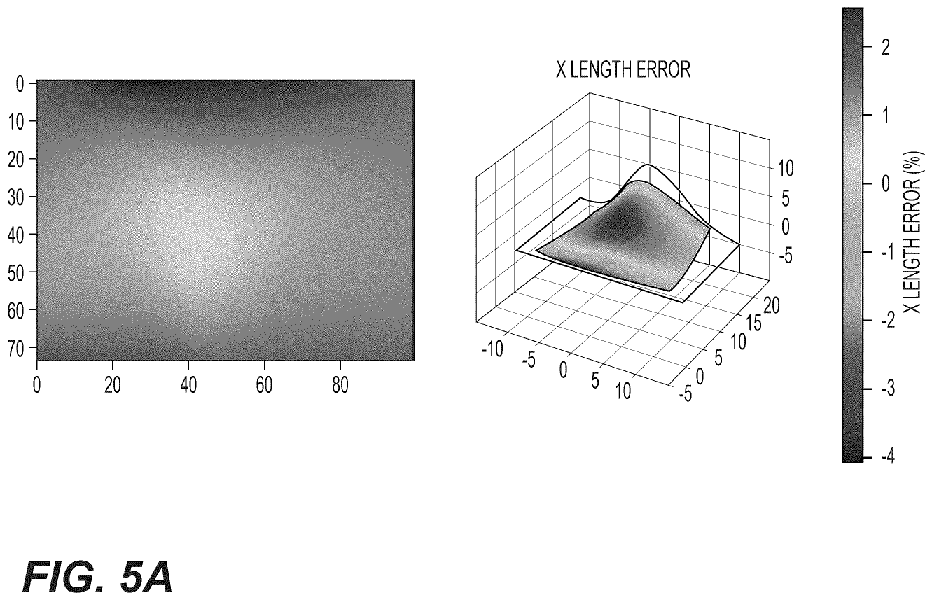

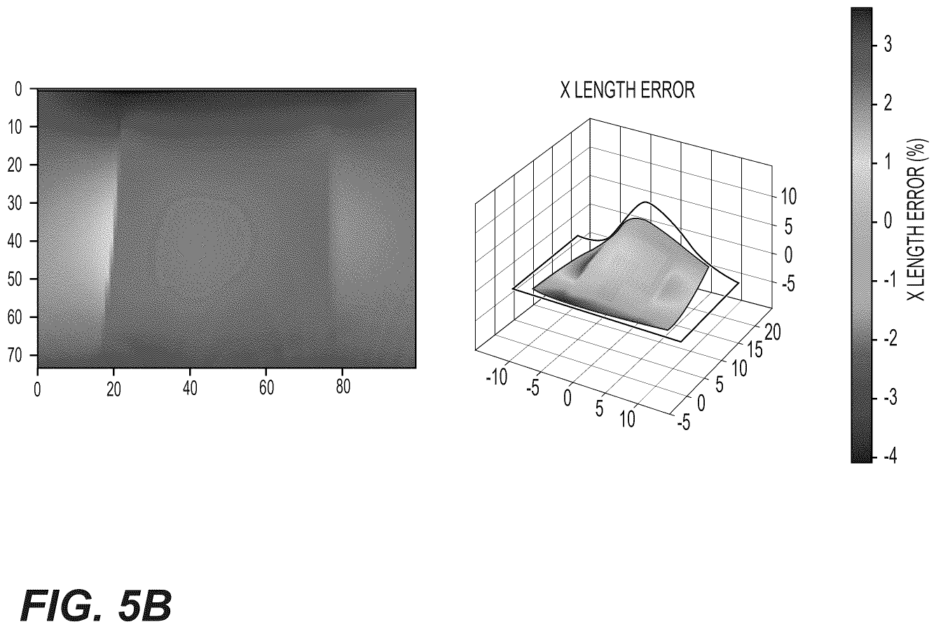

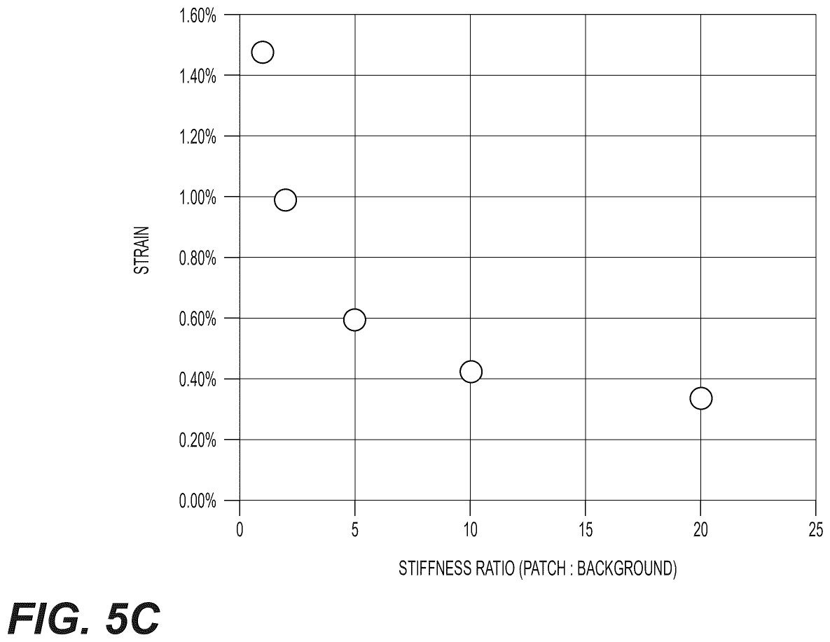

Advantageously, while localized stiffening does substantially reduce the distortion in the central region where the 2D geometry 400 is wrapped onto the 3D surface 402, distortion will need to be accommodated elsewhere in order to successfully flatten the 3D surface. However, the distortion can essentially be pushed into less critical regions. In FIGS. 5A-5C, the relative stiffnesses of the 2D patch geometry 400 on the 3D saddle surface 402 is changed. In particular, in FIG. 5A, the stiffness is 1 (i.e., a 1:1 ratio of the 2D geometry 400 to the rest of the 3D surface) everywhere across the 3D surface 402, and the strain relative to this stiffness is mapped on the grid. In FIG. 5B, a 10:1 relative stiffness ratio was applied to the 2D patch geometry 400 in the center of the 3D saddle surface 402. Based on a comparison of FIGS. 5A and 5B, the bounds of the locally stiff 2D patch geometry 402 are visibly apparent, and the error (strain in the X-direction) is notably reduced from 1.48% to 0.42% as shown in FIG. 5C, demonstrating successful implementation of reducing local distortion of a 2D geometry.

While the decrease in error (distortion or strain) may seem small in absolute terms, this small impact can greatly affect physical properties and tolerances. One key application area for aerosol printing is radiofrequency communication devices (such as antennas and transmission lines), and small changes in geometry on this order of magnitude can substantially alter electromagnetic properties. To the best of the inventors' knowledge, no other wrapping methodology enables this sort of localized distortion adjustment.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein.

Indeed, his methodology could readily extend to other motion systems, manufacturing technologies, and applications outside manufacturing in which mapping a 2D (or layer-by-layer) pattern onto a 3D part is required. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method of conformal patterning of a feature on a three-dimensional surface, comprising the steps of:
parameterizing the three-dimensional surface in two dimensions to form a two-dimensional canvas;
applying at least one optimization function to the two-dimensional canvas based on corresponding coordinates from the three-dimensional surface;
interpolating a two-dimensional pattern on the two-dimensional canvas to form a patterned two-dimensional canvas; and
remapping values of the patterned two-dimensional canvas to the three-dimensional surface to form a conformal pattern.

2. The method of claim 1, further comprising carrying out a manufacturing operation to apply the feature on the three-dimensional surface using the conformal pattern.

3. The method of claim 1, wherein the step of parameterizing the three-dimensional surface in two dimensions to form the two-dimensional canvas comprises using a non-uniform rational B-splines (NURBS) definition.

4. The method of claim 3, wherein the step of remapping values of the patterned two-dimensional canvas to the three-dimensional surface comprises using the NURBS definition.

5. The method of claim 4, wherein the step of remapping values of the patterned two-dimensional canvas to the three-dimensional surface using the NURBS definition further comprises the step of calculating surface normal direction using a continuous, curved surface representation to support multi-axis motion planning using the NURBS definition.

6. The method of claim 1, wherein applying the at least one optimization function further comprises the step of maintaining point-to-point distances along parametric coordinates of the two-dimensional canvas.

7. The method of claim 1, wherein applying the at least one optimization function further comprises maintaining angles, areas, or a combination of angles and areas within local elements defined by the two-dimensional canvas.

8. The method of claim 1, wherein applying at least one optimization function further comprises providing a local region within the 3D surface of altered stiffness relative to a rest of the 3D surface.

9. The method of claim 8, wherein providing the local region with altered stiffness reduces strain on the feature.

10. The method of claim 2, wherein carrying out the manufacturing operation further comprises performing an additive manufacturing process.

11. The method of claim 10, wherein the additive manufacturing process is aerosol printing.

12. The method of claim 2, wherein carrying out the manufacturing operation further comprises performing a subtractive manufacturing process.

13. The method of claim 1, wherein, prior to parameterizing, the method further comprises obtaining the three dimensional surface using a three dimensional scanner.

14. The method of claim 1, wherein, prior to parameterizing, the method further comprises developing the three-dimensional surface through computer-aided design software.

15. A non-transitory, computer-readable storage medium comprising program instructions that, when executed by a processor, are configured to perform the method according to claim 1.

16. A system, comprising:
a processor; and
a memory storing program code comprising program instructions;
wherein, when the processor executes the program code stored on the memory, the system is configured to perform the method according to claim 1.
